(19) United States
(12) Patent Application Publication
(10) Pub. No.: US 2026/0220121 A1
(43) Pub. Date: Jul. 30, 2026

(54) SYSTEMS AND METHODS FOR EFFICIENT UPDATES OF COMPOSITE MESSAGING FILES

(71) Applicant: RELATIVITY ODA LLC, Chicago, IL (US)

(72) Inventors: Michael Maletich, Chicago, IL (US); Greg Ott, Chicago, IL (US); Alex Wilcoxson, Chicago, IL (US)

(21) Appl. No.: 19/036,959

(22) Filed: Jan. 24, 2025

(51) Int. Cl. G06F 16/23; G06F 16/14

(52) U.S. Cl. CPC G06F 16/2365; G06F 16/148

(57) ABSTRACT

The following relates generally to updating composite messaging files. In some embodiments, one or more processors: maintain an update log for the composite messaging file, wherein the update log includes update log rows and update log columns, wherein the update log rows correspond to an update to respective component messages of the plurality of component messages, and the update log columns include a validity column indicating which columns of the update log row include valid data indicative of a current state of the respective component messages; detect a sync request associated with the composite messaging file; and in response to detecting the sync request, update the composite messaging file.

### INCORPORATION BY REFERENCE

U.S. Provisional Application No. 63/613,523, entitled “Systems and Methods for Managing a Unified Metadata Database,” (filed Dec. 21, 2023) is incorporated by reference herein.

### FIELD

The present disclosure generally relates to efficiently updating composite messaging files.

### BACKGROUND

In the eDiscovery process commonly associated with litigation, for example, reviewers (e.g., attorneys) are commonly provided with a voluminous corpus of documents (e.g., emails, SMS communications, group texts, presentations, reports, spreadsheets, etc.) that conform to a discovery request. To this end, reviewers may mark a document, or messages within a document as “responsive” (e.g., as responsive to an inquiry), and/or mark the document or message with other information.

However, in some instances, it may be cumbersome to maintain an updated file storage system for such purposes. For example, to achieve certain advantages, some systems maintain multiple messages in the same file (e.g., 10,000 messages in the same document). Thus, to mark a single message in the file as responsive, the system must read out and write back the entire file (including all of the messages in the file) to mark the single message as responsive.

The systems and methods disclosed herein provide solutions to these problems and may provide solutions to the ineffectiveness, insecurities, difficulties, inefficiencies, encumbrances, and/or other drawbacks of conventional techniques.

### SUMMARY

In one aspect, a computer-implemented method for updating a composite messaging file that is a compilation of a plurality of component messages is provided. The composite messaging file may include a data file and a component message table indicative of a position of data within the data file. The method comprises (1) maintaining, via one or more processors, an update log for the composite messaging file, wherein the update log includes update log rows and update log columns, wherein the update log rows correspond to an update to respective component messages of the plurality of component messages, and the update log columns include a validity column indicating which columns of the update log row include valid data indicative of a current state of the respective component messages; (2) detecting, via the one or more processors, a read request associated with a field of a component message of the composite messaging file, wherein the field of the component message corresponds to an update log column; (3) in response to detecting the read request, querying, via the one or more processors, the update log to detect an update associated with the field of the component message; and (4) in response to detecting the update associated with the field of the component message, returning, via the one or more processors, information associated with the field of component message from the update log. The method may include additional, fewer, or alternate actions, including those discussed elsewhere herein.

In another aspect, a computer device for updating a composite messaging file that is a compilation of a plurality of component messages is provided. The composite messaging file may include a data file and a component message table indicative of a position of data within the data file. The computer device comprising one or more processors configured to (1) maintain an update log for the composite messaging file, wherein the update log includes update log rows and update log columns, wherein the update log rows correspond to an update to respective component messages of the plurality of component messages, and the update log columns include a validity column indicating which columns of the update log row include valid data indicative of a current state of the respective component messages; (2) detect a read request associated with a field of a component message of the composite messaging file, wherein the field of the component message corresponds to an update log column; (3) in response to detecting the read request, query the update log to detect an update associated with the field of the component message; and (4) in response to detecting the update associated with the field of the component message, return information associated with the field of component message from the update log. The computer device may include additional, less, or alternate functionality, including that discussed elsewhere herein.

In yet another aspect, a computer system for updating a composite messaging file that is a compilation of a plurality of component messages is provided. The composite messaging file may include a data file and a component message table indicative of a position of data within the data file. The computer system comprises (i) one or more processors; and (ii) one or more non-transitory memories, the one or more non-transitory memories having stored thereon computer-executable instructions that, when executed by the one or more processors, cause the one or more processors to (1) maintain an update log for the composite messaging file, wherein the update log includes update log rows and update log columns, wherein the update log rows correspond to an update to respective component messages of the plurality of component messages, and the update log columns include a validity column indicating which columns of the update log row include valid data indicative of a current state of the respective component messages; (2) detect a read request associated with a field of a component message of the composite messaging file, wherein the field of the component message corresponds to an update log column; (3) in response to detecting the read request, query the update log to detect an update associated with the field of the component message; and (4) in response to detecting the update associated with the field of the component message, return information associated with the field of component message from the update log. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer environment updating composite messaging files in which the exemplary computer-implemented methods described herein may be implemented.

FIG. 2 depicts an example computing system, according to an embodiment.

FIG. 3A depicts an example computer-implemented method of updating composite messaging files.

FIG. 3B depicts an example method including a read request.

FIG. 3C depicts an example method including a sync request.

FIG. 4 depicts an example diagram of maintaining a component message table.

FIG. 5 depicts an example diagram of maintaining a component message table, and inserting a new row into the update log.

FIG. 6 depicts an example diagram of maintaining a component message table following a sync event.

FIG. 7 depicts another example method including a sync request.

FIG. 8 depicts another example method including a read request.

### DETAILED DESCRIPTION

In the eDiscovery process commonly associated with litigation, for example, reviewers (e.g., attorneys) are commonly provided with a voluminous corpus of documents (e.g., emails, SMS communications, group texts, presentations, reports, spreadsheets, etc.) that conform to a discovery request. To this end, reviewers may mark a document, or messages within a document as “responsive” (e.g., as responsive to an inquiry), and/or mark the document or message with other information.

However, in some instances, it may be cumbersome to update the file storage system as documents are reviewed. For example, to achieve certain advantages, some systems maintain multiple component messages as a composite messaging file (e.g., a Relativity Short Message Format (RSMF) file). As will be explained below, a composite messaging file may include an unstructured data file at which the metadata associated with the component messages is maintained and a map file (also called a “component message table” herein) identifying the location of the metadata. Thus, to update the data file to indicate that a single component message is, for example, responsive, the system may need to parse through the entire data file up until the bits at which the metadata field for the single component message is located. Accordingly, parsing through the data file for each update to component message metadata may take a significant amount of time.

The systems and methods disclosed herein provide solutions to these problems and others. For example, some embodiments maintain an update log at which the updates are temporarily stored. Accordingly, rather than updating the data file each time the metadata is updated, the updated metadata is included in a new row appended to the update log. As a result, when the disclosed systems parse through the data file, multiple fields of metadata can be updated in a single pass. Compared to previous systems, in some scenarios, embodiments described herein improve processing time to update component message metadata by approximately one thousand fold.

### Example Environment

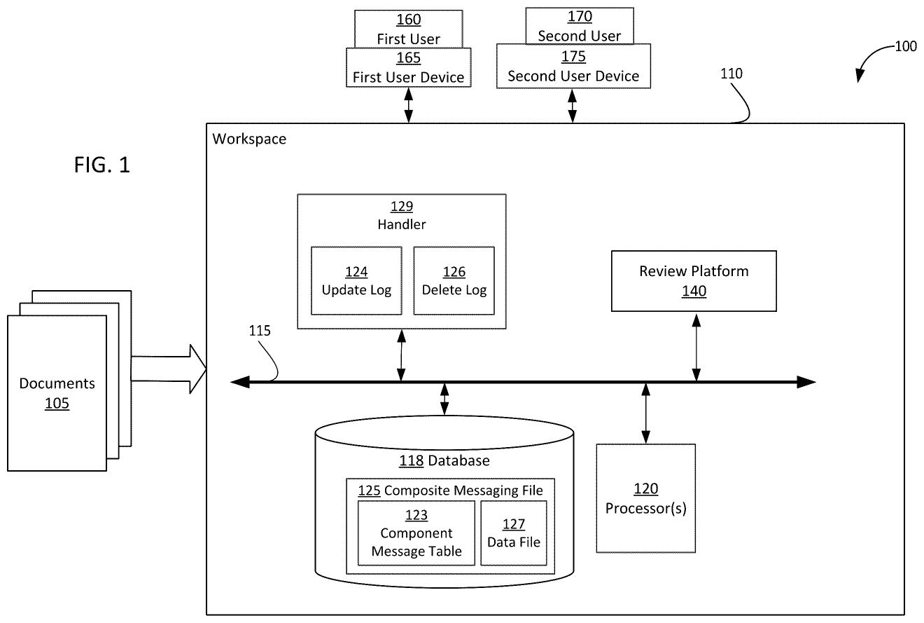

To this end, FIG. 1 illustrates an exemplary computer environment 100 for updating composite messaging files in which the exemplary computer-implemented methods described herein may be implemented. The high-level architecture includes both hardware and software applications, as well as various data communications channels for communicating data between the various hardware and software components.

As illustrated, the computing environment 100 includes a workspace 110 associated with a corpus of documents 105 (e.g., files, etc.), such as a set of documents associated with an eDiscovery project. Such documents in the corpus of documents 105 may be various file types. In one example, the file type includes aggregated message file types, such as a Parquet file type, etc. Further examples of the file type include: an email file, a word processing file, a spreadsheet file, an audio recording, imagery data (e.g., image and/or video data), a text message, etc.

The workspace 110 and/or the components thereof may be implemented as software modules within a cloud and/or distributed computing system (e.g., Amazon Web Services (AWS) or Microsoft Azure). Accordingly, the components of the workspace 110 may include separate logical addresses via which the components are accessible via a bus 115 or other messaging channel supported by the cloud computing system. In some embodiments, the workspace 110 includes multiple instances of the same component to increase the ability the parallelization for the various functions performed via the respective components.

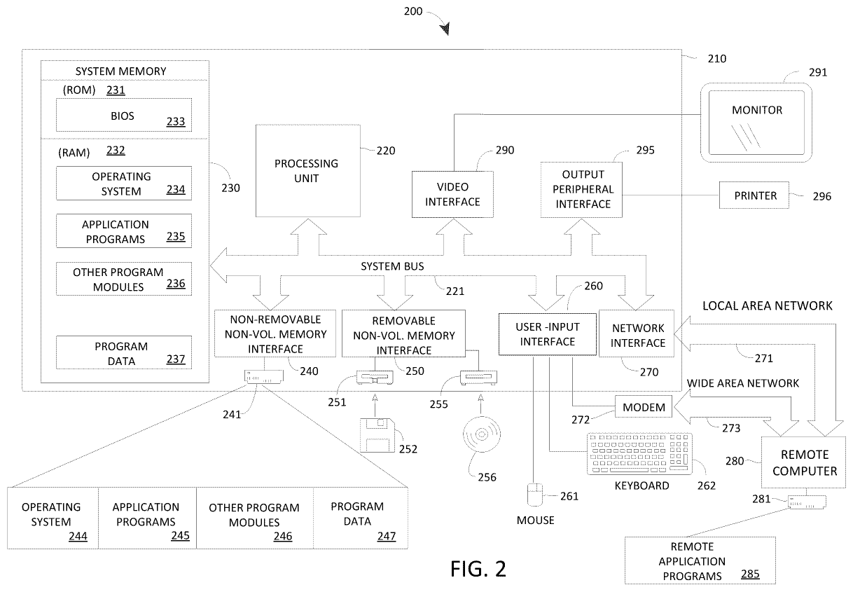

To implement the computing environment 100, a computing system may be used. With simultaneous reference to FIG. 2, illustrated is an example computing system 200 that may be configured to host and/or execute at least a portion of the workspace 110. The computing system 200 may include a computer 210. Components of the computer 210 may include, but are not limited to, a processing unit 220, a system memory 230, and a system bus 221 that couples various system components including the system memory 230 to the processing unit 220. In some embodiments, the processing unit 220 may include one or more parallel processing units capable of processing data in parallel with one another. The system bus 221 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 210 may include a variety of computer-readable media. Computer-readable media may be any available media that can be accessed by computer 210 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 210.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to, and/or presently being operated on, by processing unit 220. By way of example, and not limitation, FIG. 2 illustrates operating system 234, application programs 235, other program modules 236, and program data 237. For example, the application programs 235, the program modules 236 and/or the program 237 may include any of the applications executed within the workspace 110.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 may be connected to the system bus 221 through a non-removable memory interface such as interface 240, and magnetic disk drive 251 and optical disk drive 255 may be connected to the system bus 221 by a removable memory interface, such as interface 250.

The drives and their associated computer storage media discussed above and illustrated in FIG. 2 provide storage of computer-readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as cursor control device 261 (e.g., a mouse, trackball, touch pad, etc.) and keyboard 262. A monitor 291 or other type of display device is also connected to the system bus 221 via an interface, such as a video interface 290. In addition to the monitor, computers may also include other peripheral output devices such as printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and may include many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in hospitals, offices, enterprise-wide computer networks, intranets and the Internet.

When used in a LAN networking environment, the computer 210 is connected to the LAN 271 through a network interface or adapter 270. When used in a WAN networking environment, the computer 210 may include a modem 272 or other means for establishing communications over the WAN 273, such as the Internet. The modem 272, which may be internal or external, may be connected to the system bus 221 via the input interface 260, or other appropriate mechanism. The communication connections 270, 272, which allow the device to communicate with other devices, are an example of communication media, as discussed above. In a networked environment, program modules depicted relative to the computer 210, or portions thereof, may be stored in the remote memory storage device 281. By way of example, and not limitation, FIG. 2 illustrates remote application programs 285 as residing on memory device 281.

In some embodiments, the computing system 200 may include any number of computers 210 configured in a cloud or distributed computing arrangement. Accordingly, the computing system 200 may include a cloud computing manager system (not depicted) that efficiently distributes the performance of the functions described herein between the computers 210 based on, for example, a resource availability of the respective processing units 220 or system memories 230 of the computers 210. In these embodiments, the documents in the corpus of documents may be stored in a cloud or distributed storage system (not depicted) accessible via the interfaces 271 or 273. Accordingly, the computer 210 may communicate with the cloud storage system to access the documents within the corpus of documents.

As illustrated, the workspace 110 includes various modules, applications, etc., that can be executed within the workspace 110. In some embodiments, the applications executing within the workspace 110 may be configured to facilitate the classification of documents (and/or message within a document) in the corpus of documents 105 (e.g., by marking a document or message as “responsive” or “not responsive,” etc.). Accordingly, the corpus of documents 105 may be stored at one or more locations, including a local database or cache 118 and/or a remote storage system (not depicted), such as a data lake or other cloud-storage system.

Messages and/or documents may be classified by the first user 160 (e.g., via the first user device 165) and/or the second user 170 (e.g., via the second user device 175) via a graphical user interface of the first user device 165 and/or second user device 175. Examples of the first user 160 and/or second user 170 include attorneys, case managers, reviewers, anyone involved in a document review process, etc. Accordingly, examples of the first user device 165 and/or the second user device 175 include user devices of: attorneys, case managers, reviewers, anyone involved in a document review process, etc. In this regard, examples of the first user device 165 and/or the second user device 175 may include any suitable device(s), such as a computer, a mobile device, a smartphone, a laptop, a phablet, a chatbot or voice bot, etc. The first user device 165 and/or the second user device 175 may include one or more display devices, one or more processors, one or more memories, etc.

As illustrated, the workspace 110 includes a review platform 140 to facilitate manual review of any documents. In some embodiments, the review platform 140 may be configured to present one or more graphical user interface (GUIs) on the first user device 165 and/or the second user device 175. Accordingly, the review platform 140 and the first user device 165 and/or the second user device 175 may be communicatively coupled via one or more communication networks. For example, the communication networks one or more wired and/or wireless local area networks (LANs), and/or one or more wired and/or wireless wide area networks (WANs), such as the Internet.

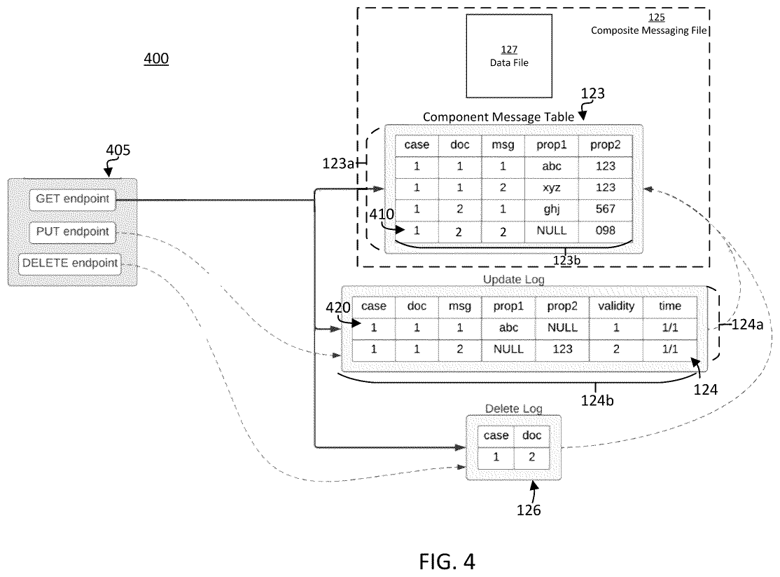

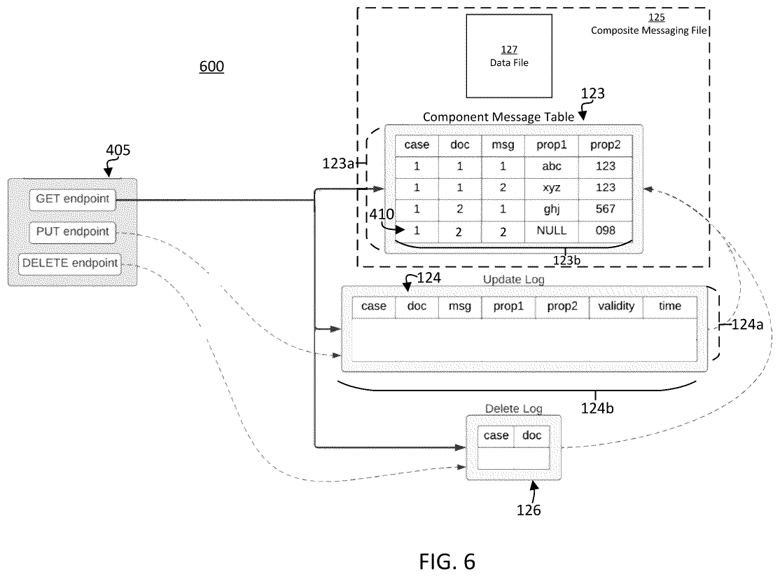

In addition, as will be described in more detail elsewhere herein (e.g., with respect to FIGS. 4-6), the memory 122 may include composite messaging file 125 including a component message table 123 and unstructured data file 127. Although in the illustrated examples unstructured data file 127 is depicted, it should be appreciated that, additionally or alternatively, data file 127 may be used in accordance with the techniques described herein.

Furthermore, although the example environment 100 illustrates only one of each of the components, any number of the example components are contemplated (e.g., any number of computing devices, first user devices, second user devices, databases, composite messaging files, component message tables, unstructured data files, etc.).

### Example Methods

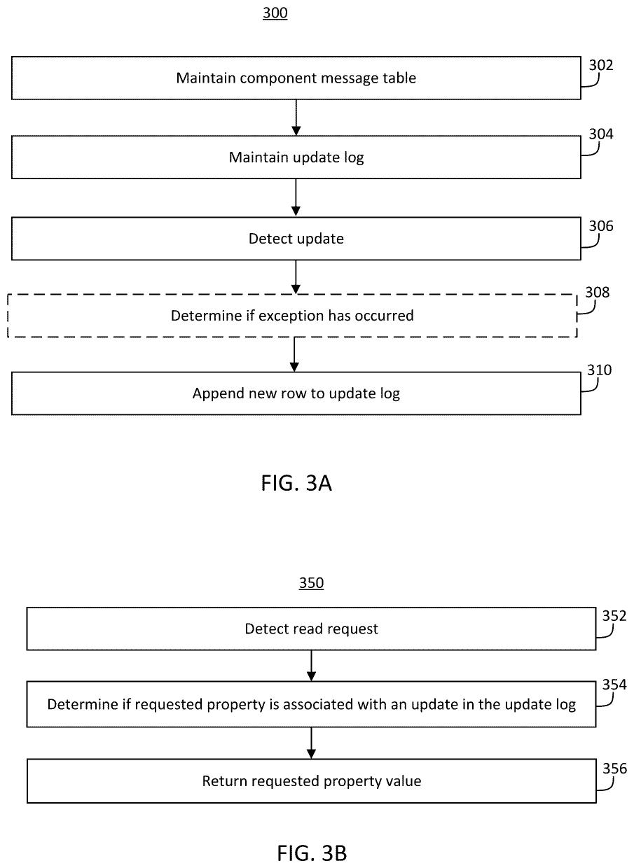

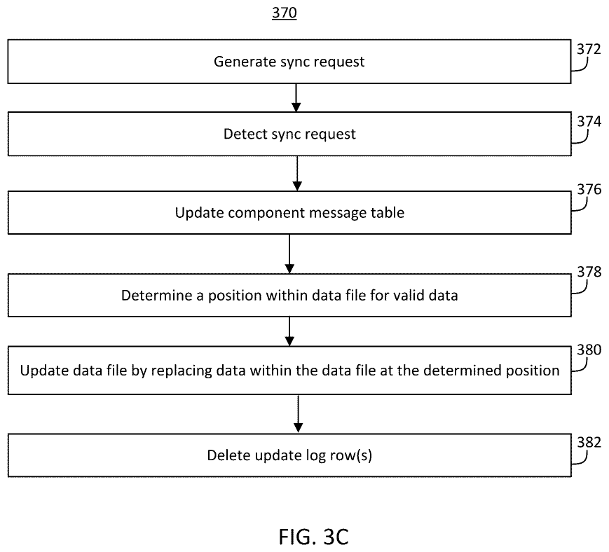

FIG. 3A illustrates a flow diagram representing an exemplary computer-implemented method 300 for updating composite messaging files. The example method 300 may be implemented by a computing environment 100 hosting the workspace 110.

The example method 300 may begin at block 302 when the one or more processors 120 maintain the component message table 123. With simultaneous reference to FIG. 4, FIG. 4 illustrates an example diagram 400 depicting how the computing environment 100 maintains a component message table 123, an update log 124, and a delete log 126, in accordance with some embodiments described herein. In the illustrated example, the example component message table 123 includes component message table rows 123a, and component message table columns 123b. In some embodiments, the rows 123a may correspond to the component messages maintained in the composite messaging file 125 and the columns 123b correspond to data fields associated with the corresponding component message. Some examples of the component message table columns 123b include: (i) a case column; (ii) a document column; (iii) a message column; and/or (iv) at least one property column. In some examples, the case column information indicating a case (e.g., a lawsuit, such as ABC Corp. v. XYZ Corp., etc.). In some examples, the document column indicates a document identifier that uniquely identifies a particular document in the corpus of documents 105. As discussed above, the document may correspond to a file type that includes multiple component messages, such as a file type utilized to export messages from a messaging service (e.g., Slack, Teams, SMS, a RSMF file, etc.), a Parquet file type, etc. Further examples of the file type include: an email file, a word processing file, a spreadsheet file, an audio recording, imagery data (e.g., image and/or video data), a text message, etc. In some examples where the documents include multiple component messages, the message column may indicate a particular message that is included in the document indicated by the document column.

In some examples, the component message table columns 123b include at least one property column corresponding to different types of data associated with the message, such as message content, message metadata maintained in the document file (e.g., author, recipient(s), message time, etc.), and message metadata generated by an application within the workspace 110 (e.g., labels indicative of relevance to an inquiry or a privilege claim). In the illustrated example, there are only two property columns illustrated, but other embodiments may have any number of property columns. It should be appreciated that although FIG. 4 depicts the value for the data field represented by the property, in other embodiments, the value for property in the component message table may be a location in the data file at which the value for the data field is maintained. In this sense, the component message table 123 may sometimes be referred to as a map to the data file 127.

By maintaining the component message table 123 separate from the data file 127, embodiments of the present invention have technical advantages over prior systems. Particularly, when a prior system marked a message as relevant, the entire document must be read out until the particular location associated with the relevance field for the message is reached. As a composite messaging file 125 may include many thousands of messages, this process of reading out the data may take a significant amount of time. Advantageously, the techniques described herein reduce or eliminate these technical problems. For example, by utilizing the update log 124 to maintain updates to the properties of the component messages as described herein, the system reduces the number of times that the document must be read out and written back to memory (and/or parsed). For example, if, within the update time period, multiple message properties within the same document are modified (e.g., by the users 160, 170), the system may write each pending update to the data file 127 in a single pass, thereby significantly reducing the processing time to perform the update. This is particularly advantageous in eDiscovery systems, such as systems that advantageously use a document file format to include multiple messages (e.g., a Parquet file format, etc.). It may be noted that documents in such a composite file format are often on the order of hundreds of megabytes or gigabytes.

Furthermore, the component message table 123 may be included in a composite messaging file 125. As illustrated by the example of FIG. 4, the composite messaging file 125 may also include unstructured data file 127 (e.g., a JavaScript Object Notation (JSON) file, etc.).

At block 304, the one or more processors 120 maintain the update log 124. As illustrated in the example diagram 400, the update log 124 may have update log rows 124a, and update log columns 124b. In some embodiments, the rows 124a may include a row for each update to a component message and the update log rows 124b include the same data fields as the component message table columns columns 123b, as well as additional columns 123b for fields particularly associated with updates. For example, the additional columns 123b may include a validity column and a timestamp column.

In some examples, the validity column indicates which of the property columns includes valid data to use when updating the composite messaging file 125. To this end, because the update log 124 is maintained as a data table, if only a single message property or field is modified, the system still may need to generate placeholder values for the other columns. Thus, the validity indicator may indicate which property columns include valid data to use in the update to avoid updating the composite messaging file 125 with a placeholder value. In some embodiments, the validity indicator may be structured as a bit string where each bit corresponds to a property column. In these embodiments, a value of 1 may indicate that the corresponding column includes valid data and a value of 0 may indicate that the corresponding column does not include valid data.

As mentioned above, in some examples, the update log 124 may include a row 124a for each update received (e.g., via the endpoints 405, etc.). In some such examples, the updates may update any number of message properties. For instance, in the illustrated example, the system may have assigned the prop1 column the rightmost bit of the validity indicator and the prop2 column to the bit second from the right. Accordingly, in the illustrated example the first row of the rows 124a indicates that the prop1 column include valid data, but not prop2 (e.g., because the validity value is “01”). Similarly, in the second row of the row 124a, the validity value indicates that the prop 2 column includes valid data, but not the prop1 column (e.g., because the validity value is “10”).

In some embodiments, determining the component message table columns associated with valid data includes determining the component message table column by: (i) applying bit shifting to the first update log row; and/or (ii) applying, a bitwise AND technique to the first update log row. That is, in some examples, the bitwise AND operation is performed to determine whether the nth column has valid data. If a value of 1 is used to indicate that a column has valid data (i.e., the bit in the n^{th} column is a 1), the AND operation results in 1; otherwise, the AND operation results in a 0. Thus, in these examples, detecting a 1 output of the AND operation indicates that the nth column has valid data.

At block 306, the one or more processors 120 may detect a new update to a message of the composite messaging file 125. As illustrated, the update may be detected via a PUT endpoint of the endpoints 405 at which write requests are received. At optional block 308, the one or more processors 120 may determine if an exception has occurred. Broadly speaking, an exception may be determined if a user tried to modify a file or message that was modified in a pending update by a different user. Advantageously, this may alert a user that an update did not go through. For example, if the first user 160 attempted to update a message; and, quickly thereafter, the second user 170 attempted to update the message, one or both of the users 160, 170 may be notified that their updated did not go through (e.g., because one update trumped the other update, or because the system prevented both updates, etc.).

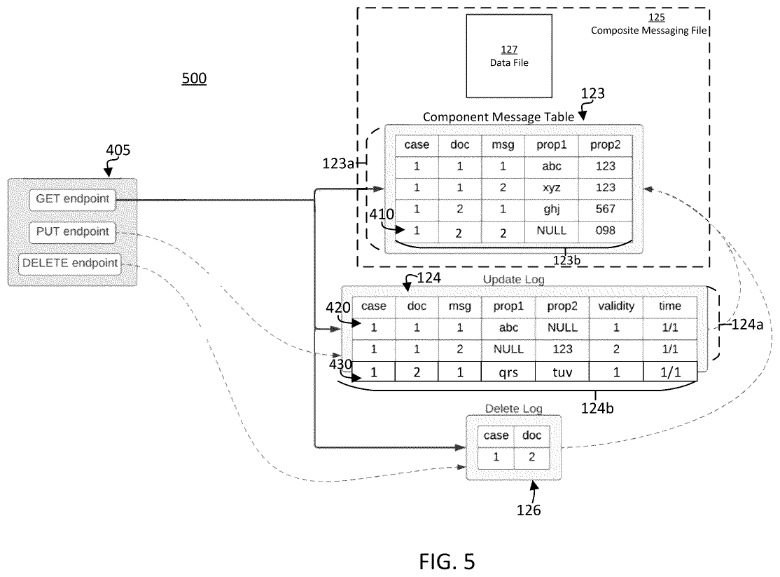

At block 310, in response to detecting the update, the one or more processors 120 may append a new update log row 124a to the update log 124. With simultaneous reference to FIG. 5, FIG. 5 illustrates an example diagram 500 of updating the update log 124. In some embodiments, the one or more processors 120 analyze the detected update to identify the updated message to generate the appropriate values for the update log columns 124b. For example, the one or more processors 120 may analyze the detected update to identify which properties or fields are updated by the update to generate the appropriate values for the property columns. If there is a property column not referenced by the update, the one or more processors 120 may generate a placeholder value to use in that column. Based on which property columns are updated by the detected update, the one or more processors 120 may generate a validity indicator that indicates the appropriate columns.

It should be appreciated that when the updates to the messages are present in the update log 124, the composite messaging file 125 may not include the latest value for the updated properties. Accordingly, there may be a need for additional processing of read requests detected via a GET endpoint of the endpoints 405 to ensure the latest version of the property value is returned.

FIG. 3B depicts an example method 350 for responding to a read request. The example method 350 may begin at block 352 when the one or more processors 120 detect (e.g., via the GET endpoint) a read request associated with a message in the workspace. The read request may be a request to provide, for example, one or more properties of a message, such as the message contents (e.g., prop1) of message 1 of document 1 of the example of FIG. 4.

At block 354, the one or more processors 120 determine whether the requested property is associated with an update in the update log 124. For example, the one or more processors 120 may compare a document and message identifier in the read request to the document and message identifiers in the corresponding columns of the update log. If there is no entry in the update log corresponding to the document and message identifiers, the one or more processors 120 may obtain the requested property value from the composite messaging file 125. On the other hand, if there is a row 124a in the update log 124 associated with the document and message identifier, the one or more processors 120 may determine whether the validity value for the corresponding row 124a indicates that the requested property value is valid. If there are no valid values for the requested property, the one or more processors 120 may obtain the requested property value from the composite messaging file 125. If there is a valid value for the requested property in the update log 124, the one or more processors 120 may instead obtain the most recent valid value for the requested property from the update log 124.

At block 356, the one or more processors 120 return the requested property value to the requesting endpoint 405.

FIG. 3C depicts an example method 370 for processing a sync request. The sync request may be a request to synchronize the updates in the update log 124 with the composite messaging file 125. Both the component message table 123 and the data file 127 of the composite messaging file 125 may be updated as part of the synchronization process.

The example method 370 may begin at block 374 when the one or more processors detect the sync request. In some embodiments, is generated based on one or both of: (i) a time since a previous sync request (e.g., ten minutes, an hour, two hours, four hours, one day, etc.), and (ii) a processing load (either current or predicted) of the one or more processors 120. Advantageously, opportunistically generating the sync request based on the processing load avoids overloading the one or more processors 120 when performing the lengthy read out of the data file 127, thereby improving technical functioning.

Subsequently, at blocks 376-380, the one or more processors 120 update the composite messaging file 125. The update of the composite messaging file 125 may include updating one or both of the component message table 123, and/or the data file 127. However, at the outset, it should be appreciated that, in some embodiments, only updates received prior to a predetermined time (e.g., the time at which the sync request is detected) are merged into the component message table 123 and/or data file 127. Advantageously, this addresses the conflict scenario where a new update log row is received after the process of updating the component message table 123 has begun.

At block 376, the one or more processors 120 update the component message table 123. In some examples, the update is performed by replacing the information indicated by both the determined component message table row and the determined component message table column with information indicated by the validity information included in the validity column of the first update log row. Thus, in the example of FIG. 4, the updated row 410 includes the maintains the values of the prop2 property but replaces the updates the value of the prop1 property with the “abc” value of prop1 from row 420.

At block 378, the one or more processors 120 determine a position within the data file 127 for valid data. As mentioned above, in some embodiments, this is accomplished by the component message table 123 “mapping” to the data file 127. That is, the value of an entry in the component message table 123 may indicate a number of bits at which the data representative of the entry begins within the data file 127.

At block 380, the one or more processors 120 may update the unstructured data file 127 by replacing data within the data file 127 at the determined position (e.g., replace data within the data file 127 with the corresponding valid data). It should be appreciated that because the update log often includes a plurality of updates, the one or more processors 120 may sequentially order the updates with respect to position in the data file 127. This way, the one or more processors 120 can update all of the updated properties on a single pass through the data file 127. Moreover, once the last sequential update is completed, the one or more processors 120 may stop reading out the data file 127, further improving the update speed.

At block 382, the one or more processors 120 delete the update log rows that were processed at steps 376-380. As some additional updates may have been received during this process, in some scenarios there are still rows of updates in the update log 124 after the processed rows are deleted.

As illustrated, in FIGS. 4-6, the one or more processors 120 may also maintain a delete log 126 for processing delete requests (such as those received via the DELETE endpoint of the endpoints 405). The delete log 126 may be a table that indicates which data is to be deleted (e.g., a particular document within a case). Accordingly, when the one or more processors 120 perform the updates at blocks 376-380, the one or more processors may also delete the indicated rows of the component message table 123 and/or the corresponding data from the data file 127. It should be appreciated that deleting data in the data file 127 may shift the position of the subsequent data. Accordingly, the one or more processors 120 may update the mapping maintained in the component message table 123 to reflect the updated positions within the data file 127.

It should be appreciated that any or all of the information discussed with respect to FIGS. 3A-3C (e.g., the update log 124, the delete log 126, the composite messaging file 125, the component message table 123, the data file 127, etc.), may be displayed at any point in the example methods 300, 350, 370 (e.g., via a display device of the first user device 165, a display device of the second user device 175, etc.).

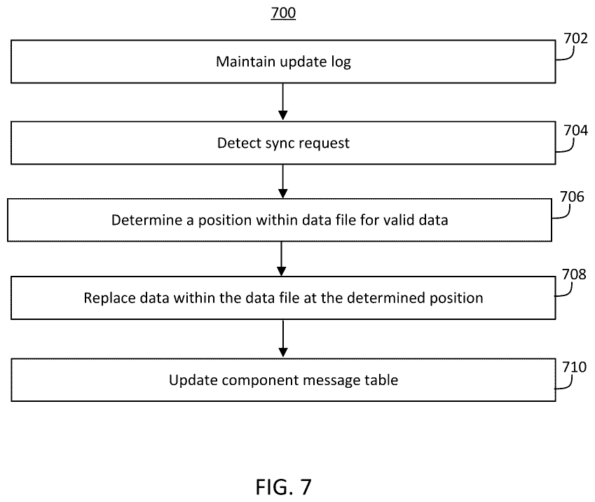

FIG. 7 depicts an example method 700 including a sync request. The example method 700 may begin at block 702 when the one or more processors 120 maintain the component message table 123.

At block 704, the one or more processors 120 detect a sync request. At block 706, the one or more processors 120 determine a position within the data file 127 for valid data. At block 708, the one or more processors 120 replace data within the data file 127 with the corresponding valid data. At block 710, the one or more processors 120 update the component message table 123 to indicate a position of the corresponding valid data within the data file 127. Any or all of blocks 706, 708, and/or 710 may be performed in response to the detection from block 704.

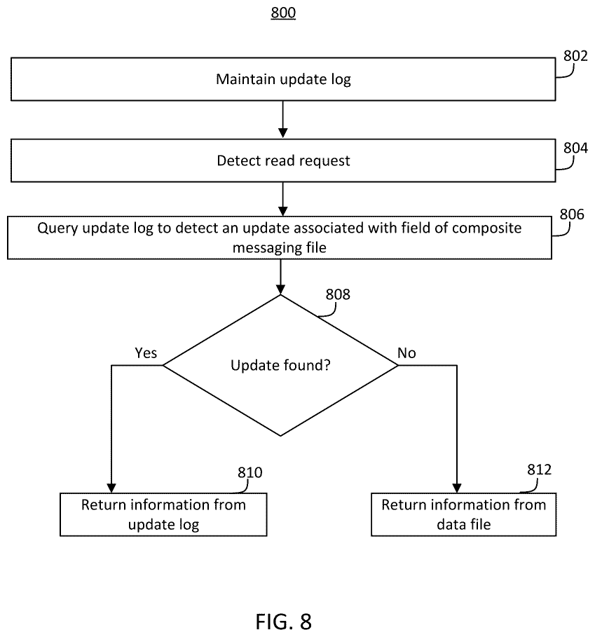

FIG. 8 depicts an example method 800 including a read request. The example method 800 may begin at block 802 when the one or more processors 120 maintain the component message table 123. At block 804, the one or more processors 120 detect a read request. At block 806, the one or more processors 120 query update log 124 to detect an update associated with field of composite messaging file 125.

At block 808, the one or more processors 120 determine if an update associated with field of composite messaging file 125 is detected. If so, at block 810, the one or more processors 120 return information associated with the field of component message from the update log 124. If not, at block 812, the one or more processors 120 return information associated with the field of component message from the date file 127.

Following either blocks 810 or 812, the example method 800 may return to either block 802 or 804 for iteration. For example, the example method 800 may return to block 804 to detect a second read request.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

1. A computer-implemented method for updating a composite messaging file that is a compilation of a plurality of component messages, wherein the composite messaging file includes a data file and a component message table indicative of a position of data within the data file, the method comprising:
maintaining, via one or more processors, an update log for the composite messaging file, wherein the update log includes update log rows and update log columns, wherein the update log rows correspond to an update to respective component messages of the plurality of component messages, and the update log columns include a validity column indicating which columns of the update log row include valid data indicative of a current state of the respective component messages, wherein (i) a validity value of the validity column is a sequence of bits and (ii) bits within the sequence of bits correspond to respective columns in the update log columns;
detecting, via the one or more processors, a read request associated with a field of a component message of the composite messaging file, wherein the field of the component message corresponds to an update log column;
in response to detecting the read request, querying, via the one or more processors, the update log to detect an update associated with the field of the component message; and
in response to detecting the update associated with the field of the component message, returning, via the one or more processors, information associated with the field of the component message from the update log.

2. The computer-implemented method of claim 1, wherein querying the update log comprises:
determining, via the one or more processors, that an update log row corresponds to the component message.

3. The computer-implemented method of claim 1, wherein querying the update log comprises:
determining, via the one or more processors, that a validity value of the validity column for the update log row indicates the field of the component message is valid.

4. The computer-implemented method of claim 1, further including:
detecting, via the one or more processors, an update to the component message in the composite messaging file; and
in response to detecting the update, appending, via the one or more processors, a new update log row to the update log.

5. (canceled)

6. (canceled)

7. The computer-implemented method of claim 1, further comprising:
determining, via the one or more processors, whether a column is valid in the update log based on the bit corresponding to the column in the validity value.

8. The computer-implemented method of claim 1, further including:
maintaining, via the one or more processors, a delete table, wherein the rows of the delete table indicate component messages to be deleted from the composite messaging file.

9. The computer-implemented method of claim 1, wherein the component message is a first component message, and the read request is a first read request, and wherein the method further includes:
detecting, via the one or more processors, a second read request associated with a field of a second component message of the composite messaging file;
in response to detecting the second read request, querying, via the one or more processors the update log; and
in response to not detecting the update associated with the field of the second component message, returning, via the one or more processors, information associated with the field of the second component message from the data file.

10. A computer device for updating a composite messaging file that is a compilation of a plurality of component messages, wherein the composite messaging file includes a data file and a component message table indicative of a position of data within the data file, the computer device comprising one or more processors configured to:
maintain an update log for the composite messaging file, wherein the update log includes update log rows and update log columns, wherein the update log rows correspond to an update to respective component messages of the plurality of component messages, and the update log columns include a validity column indicating which columns of the update log row include valid data indicative of a current state of the respective component messages, wherein (i) a validity value of the validity column is a sequence of bits and (ii) bits within the sequence of bits correspond to respective columns in the update log columns;
detect a read request associated with a field of a component message of the composite messaging file, wherein the field of the component message corresponds to an update log column;
in response to detecting the read request, query the update log to detect an update associated with the field of the component message; and
in response to detecting the update associated with the field of the component message, return information associated with the field of the component message from the update log.

11. The computer device of claim 10, wherein the one or more processors are further configured to query the update log by:
determining that an update log row corresponds to the component message.

12. The computer device of claim 10, wherein the one or more processors are further configured to query the update log by:
determining that a validity value of the validity column for the update log row indicates the field of the component message is valid.

13. The computer device of claim 10, wherein the one or more processors are further configured to:
detect an update to the component message in the composite messaging file; and
append a new update log row to the update log.

14. (canceled)

15. The computer device of claim 10, wherein the component message is a first component message, and the read request is a first read request, and wherein the one or more processors are further configured to:
detect a second read request associated with a field of a second component message of the composite messaging file;
in response to detecting the second read request, query the update log; and
in response to not detecting the update associated with the field of the second component message, return information associated with the field of the second component message from the data file.

16. A computer system for updating a composite messaging file that is a compilation of a plurality of component messages, wherein the composite messaging file includes a data file and a component message table indicative of a position of data within the data file, the computer system comprising:
one or more processors; and
one or more non-transitory memories, the one or more non-transitory memories having stored thereon computer-executable instructions that, when executed by the one or more processors, cause the one or more processors to:
maintain an update log for the composite messaging file, wherein the update log includes update log rows and update log columns, wherein the update log rows correspond to an update to respective component messages of the plurality of component messages, and the update log columns include a validity column indicating which columns of the update log row include valid data indicative of a current state of the respective component messages, wherein (i) a validity value of the validity column is a sequence of bits and (ii) bits within the sequence of bits correspond to respective columns in the update log columns;
detect a read request associated with a field of a component message of the composite messaging file, wherein the field of the component message corresponds to an update log column;
in response to detecting the read request, query the update log to detect an update associated with the field of the component message; and
in response to detecting the update associated with the field of the component message, return information associated with the field of the component message from the update log.

17. The computer system of claim 16, wherein the one or more non-transitory memories having stored thereon computer executable instructions that, when executed by the one or more processors, cause the one or more processors to query the update log by:
determining that an update log row corresponds to the component message.

18. The computer system of claim 16, wherein the one or more non-transitory memories having stored thereon computer executable instructions that, when executed by the one or more processors, cause the one or more processors to query the update log by:
determining that a validity value of the validity column for the update log row indicates the field of the component message is valid.

19. The computer system of claim 16, wherein the one or more non-transitory memories having stored thereon computer executable instructions that, when executed by the one or more processors, cause the one or more processors to:
detect an update to the component message in the composite messaging file; and
append a new update log row to the update log.

20. The computer system of claim 16, wherein the component message is a first component message, and the read request is a first read request, and wherein the one or more non-transitory memories having stored thereon computer executable instructions that, when executed by the one or more processors, cause the one or more processors to:
detect a second read request associated with a field of a second component message of the composite messaging file;
in response to detecting the second read request, query the update log; and
in response to not detecting the update associated with the field of the second component message, return information associated with the field of the second component message from the data file.
